(19) United States
(12) Patent Application Publication
(10) Pub. No.: US 2011/0287724 A1
(43) Pub. Date: Nov. 24, 2011

(54) FM TRANSMITTER, BROADCAST RECEIVER, AND METHOD FOR TRANSMITTING AUDIO

(75) Inventors: Young-joong NOH, Suwon-si (KR); Dae-hyun JANG, Suwon-si (KR)

(73) Assignee: SAMSUNG ELECTRONICS CO., LTD., Suwon-si (KR)

(21) Appl. No.: 13/090,472

(22) Filed: Apr. 20, 2011

(30) Foreign Application Priority Data
May 18, 2010 (KR) 10-2010-0046452

(51) Int. Cl. H04B 1/04; H04B 1/40; G06F 3/048; H04N 5/44

(52) U.S. Cl. 455/77; 455/120; 455/125; 715/828

(57) ABSTRACT

A frequency modulation (FM) transmitter, a broadcast receiver having the same, and a method of transmitting an audio are provided. The FM transmitter selects a specific frequency from among frequencies in FM frequency band, which exclude a frequency in use, and transmits an audio signal over the selected specific frequency. Accordingly, the FM transmitter can transmit the audio signal using the confusion-free or interference-free frequency. As a result, a user can select a frequency to transmit the audio of the broadcast receiver easily.

### CROSS-REFERENCE TO RELATED APPLICATIONS

This application claims priority from Korean Patent Application No. 10-2010-0046452, filed on May 18, 2010, in the Korean Intellectual Property Office, the disclosure of which is incorporated herein by reference in its entirety.

### BACKGROUND

1. Field

Apparatuses and methods consistent with what is described herein relate to a FM transmitter, a broadcast receiver, and a method for transmitting audio, and more particularly, to a FM transmitter transmitting an audio signal of an input image as a signal of a FM frequency band, a broadcast receiver having the same, and a method for transmitting an audio.

2. Description of the Related Art

TVs used to be the sole or main providers of image and sound at homes. But thanks to the rapid development of image technology, current viewers have various AV devices so that they can use these in a desired combination. For example, the viewers can create a home theater environment in which TV provides video screen only, while various channels of speakers reproduce audio. And yet, there are customer's continuous demands for better AV environment.

Meanwhile, connecting multiple AV devices altogether involves the following problem: it requires as many connecting lines as the AV devices. Many lines, especially at homes, cause the places to look messy, and most viewers do not know which line goes to which device.

Accordingly, in order to resolve the abovementioned problems, technologies, which enable a TV to transmit an audio signal wirelessly, have been developed. One of these wireless transmission technologies includes transmitting a TV audio signal using a FM frequency band which is generally used in radio. However, one drawback with this technology is that the FM frequency band can be used for other purposes and this can cause interference with the TV audio signal.

The viewers definitely want confusion-free, interference-free and noise-free audio. Accordingly, it is necessary to prevent confusion or interference of TV audio signals during transmission.

### SUMMARY

Exemplary embodiments overcome the above disadvantages and other disadvantages not described above. Also, the exemplary embodiments are not required to overcome the disadvantages described above, and an exemplary embodiment of the present inventive concept may not overcome any of the problems described above.

According to one exemplary embodiment, a FM transmitter, a broadcast receiver, and a method of transmitting an audio, are provided. The FM transmitter selects a predetermined frequency from among the other frequencies except the frequency in use and transmits an audio signal over a predetermined frequency.

In one exemplary embodiment, a frequency modulation (FM) transmitter may be provided. The FM transmitter may include a FM transmitting unit which transmits an audio signal using a specific frequency in FM frequency band, and a control unit which controls the FM transmitting unit so that the specific frequency in FM frequency band is selected from among frequencies that exclude a frequency in use.

The FM transmitter may additionally include a storage unit which stores therein broadcast frequency information used for a television (TV) broadcast, wherein the control unit controls so that the specific frequency is selected using the broadcast frequency information.

The control unit may control so that the specific frequency is selected from within a range that does not include a frequency included in the broadcast frequency information.

The control unit may select a frequency from among frequencies in FM frequency band as the specific frequency, in which the frequencies in FM frequency band exclude the frequency in use.

The control unit may select a frequency selected according to a user input as the specific frequency.

The control unit may display a graphic user interface (GUI) for selecting the specific frequency and selects a frequency selected by the user through the GUI as the specific frequency.

The control unit may control the GUI so that the frequency in use in FM frequency band is not selected as the specific frequency.

The FM transmitter may additionally include an audio input unit which receives an audio signal from an external device, wherein the FM transmitting unit transmits the audio signal input through the audio input unit with the specific frequency.

In one exemplary embodiment, a broadcast receiver having the abovementioned FM transmitter may be provided.

In one exemplary embodiment, a method of transmitting an audio may be provided. The method may include steps of selecting a specific frequency from among frequencies in FM frequency band that exclude a frequency in use, and transmitting an audio signal using the specific frequency in FM frequency band.

The method may additionally include the step of reading out broadcast frequency information used for television (TV) broadcast, wherein the selecting step includes a step of selecting the specific frequency using the broadcast frequency information.

The selecting step may include a step of selecting the specific frequency from within a range that does not include a frequency included in the broadcast frequency information.

The selecting step may include a step of selecting the specific frequency from among the frequencies in FM frequency band, but not the frequency in use.

The selecting step may include selecting a frequency selected by a user input as the specific frequency.

The method may additionally include a step of displaying a graphic user interface (GUI) for selecting the specific frequency, wherein the selecting step includes selecting a frequency selected by a user through the GUI as the specific frequency.

The GUI may be configured so that the frequency in FM frequency band is not selected as the specific frequency if the frequency is in use.

The method may additionally include a step of receiving an audio signal from an external device, wherein the transmitting step includes transmitting the audio signal input from the external device with the specific frequency.

In an exemplary embodiment, there is a frequency modulation transmitter including an FM transmitting unit; and a control unit which controls the FM transmitting unit so that a frequency in an FM frequency band is selected from among frequencies that are not in use, wherein the FM transmitting unit transmits an audio signal through the selected frequency in the FM frequency band.

In yet another exemplary embodiment, there is a method of transmitting an audio, the method including: selecting a frequency in a frequency modulation (FM) band from among frequencies that are not in use; and transmitting an audio signal using the selected frequency.

In an exemplary embodiment, there is a display device including: a display unit; a frequency modulation (FM) transmitting unit; a controller which controls the FM transmitting unit so that a frequency in an FM frequency band is selected from among frequencies that are not in use, wherein the FM transmitting unit transmits an audio signal through the selected frequency in the FM frequency band.

In the exemplary embodiments described above, a FM transmitter which selects a specific frequency in FM frequency band from among frequencies other than a frequency in use, and transmits an audio signal with the specific frequency, a broadcast receiver having the FM transmitter, and a method of transmitting an audio, are provided. Accordingly, the FM transmitter can transmit an audio signal using a confusion-free or interference-free frequency. As a result, the user can select a frequency to transmit an audio easily.

### BRIEF DESCRIPTION OF THE DRAWINGS

The above and/or other aspects of what is described herein will be more apparent by describing certain exemplary embodiments with reference to the accompanying drawings, in which:

FIG. 1A illustrates a structure of a television (TV) including a built-in FM transmitter according to an exemplary embodiment;

FIG. 1B illustrates an image system having a TV including a built-in FM transmitter according to an exemplary embodiment;

FIG. 2A illustrates a structure of a TV to which an external FM transmitter is connected according to an exemplary embodiment;

FIG. 2B illustrates an image system having a TV to which an external FM transmitter is connected according to an exemplary embodiment;

FIG. 3 is a flowchart provided to explain a method of transmitting an audio signal according to an exemplary embodiment;

FIG. 4A illustrates a frequency selecting GUI in an automatic select mode in which a transmission frequency is selected automatically, according to an exemplary embodiment;

FIG. 4B illustrates a frequency selecting GUI in a manual select mode in which a transmission frequency is selected manually by a user, according to an exemplary embodiment;

FIG. 5 illustrates a FM frequency band according to an exemplary embodiment;

FIGS. 6A to 6E illustrate examples of setting a transmittable frequency area according to an exemplary embodiment;

FIG. 7 illustrates a FM transmitter according to an exemplary embodiment; and

FIG. 8 is a flowchart provided to explain a method of transmitting an audio according to an exemplary embodiment.

### DETAILED DESCRIPTION OF EXEMPLARY EMBODIMENTS

Certain exemplary embodiments will now be described in greater detail with reference to the accompanying drawings.

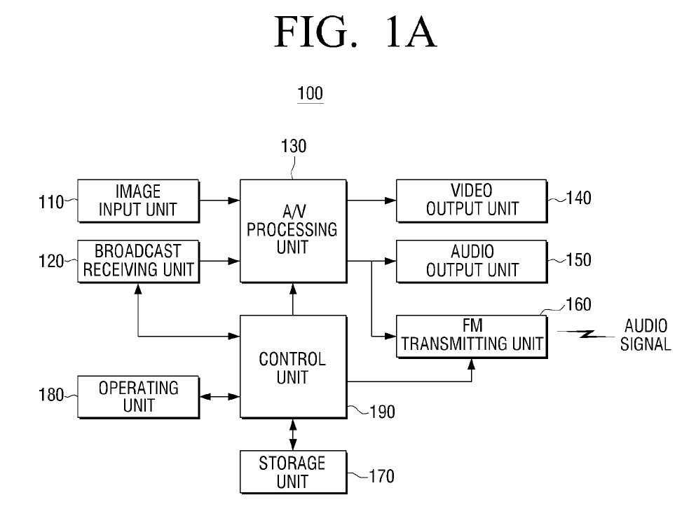

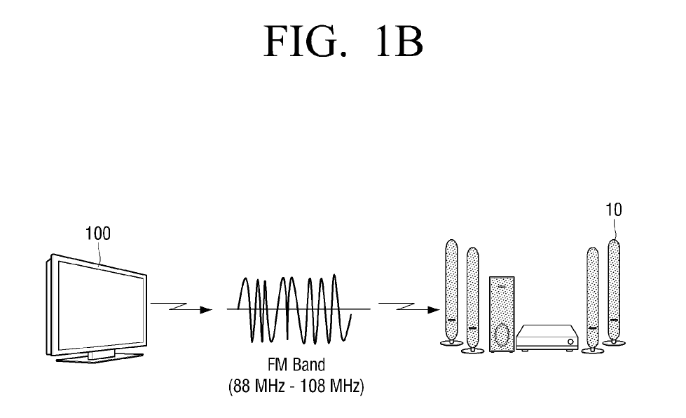

FIG. 1A illustrates a television (TV) 100 including a built-in FM transmitter according to an exemplary embodiment.

Referring to FIG. 1A, the TV 100 may include an image input unit 110, a broadcast receiving unit 120, an AV processing unit 130, a video output unit 140, an audio output unit 150, a FM transmitting unit 160, a storage unit 170, an operating unit 180, and a control unit 190. The FM transmitter may represent a device which includes the FM transmitting unit 160 and the control unit 190, and which transmits an audio signal as a FM frequency band signal.

The image input unit 110 may receive an image signal from an external source. That is, the image input unit 110 may operate as an interface to receive an analog image signal or a digital image signal from outside of the TV 100. The interface may be an AV interface such as s-video, component, composite, DVI, or HDMI. In another exemplary embodiment, the interface may include an Ethernet interface or a USB interface. The image signal may include a video signal and an audio signal.

The broadcast receiving unit 120 may receive a broadcast signal from a broadcasting station or satellite by wire or wirelessly and demodulate the received signal. To this end, the broadcast receiving unit 120 may include a tuner to tune to a broadcast receiving frequency. The broadcast signal may include a video signal and an audio signal.

The AV processing unit 130 may carry out signal processing of the image and audio signals received from the broadcast receiving unit 120, the signal processing including video decoding, video scaling, or audio decoding. The AV processing unit 130 may additionally transmit the video signal to the video output unit 140.

Additionally, the AV processing unit 130 may transmit an audio signal to the audio output unit 150 or the FM transmitting unit 160 in accordance with the setting of the audio signal. That is, if the audio is set to be output through a built-in speaker of the TV 100 or a connected external speaker, the AV processing unit 130 may output the audio signal to the audio output unit 150. If the audio signal is set to be transmitted wirelessly, the AV processing unit 130 may transmit the processed audio signal to the FM transmitting unit 160.

The video output unit 140 may display a video signal received from the AV processing unit 130. In an exemplary embodiment, the video output unit includes a screen on which the video signal is displayed. The video output unit 140 may additionally display a GUI for selecting a frequency on the screen. The GUI for selecting a frequency herein may refer to a GUI which is provided for selecting an audio signal transmitting frequency. The GUI for selecting a frequency may provide an interface via which a frequency is selected automatically or manually, which will be explained in greater detail below.

The audio output unit 150 may output an audio signal output from the AV processing unit 130 through a built-in speaker or an external device (e.g., external speaker) connected thereto through an external output terminal.

The FM transmitting unit 160 may transmit an audio signal over a transmission frequency of a FM frequency band. The ‘FM frequency band’ herein may refer to a frequency band generally used in a radio broadcasting in which the frequency modulation is applied. The FM frequency band is 88 MHz to 108 MHz in South Korea, but this may vary depending on countries, and the concept of the exemplary embodiment described herein is not limited to a specific frequency band. The ‘transmission frequency’ herein may refer to a selected frequency of the FM frequency band through which an audio signal is transmitted.

Specifically, the FM transmitting unit 160 may modulate the audio signal, processed at the AV processing unit 130, into a transmission frequency by applying frequency modulation, and transmit the modulated signal. Accordingly, the FM transmitting unit 160 transmits the audio signal of the TV 100 to the external device wirelessly.

The FM transmitting unit 160 may select the transmission frequency from among the other frequencies of the FM frequency band except for the frequency in use. The ‘frequency in use’ herein refers to a frequency which is currently used for other purposes. The broadcast receiving unit 120 may particularly utilize various channels to receive a TV broadcast signal. Accordingly, there may be a frequency in the FM frequency band, that is used at the broadcast receiving unit 120 to receive a TV broadcast signal. In this case, the FM transmitting unit 160 may select a transmission frequency from among the frequencies excluding the frequency in use, in order to avoid confusion or interference with the broadcast receiving unit 120.

The storage unit 170 may store various programs and information for the operation of the TV 100. Specifically, the storage unit 170 may store broadcast frequency information used in TV broadcasting. The ‘broadcast frequency information’ herein may refer to the frequency information of the channels through which the broadcast is provided. Accordingly, the broadcast frequency information may include frequency information for each channel such as, for example, “CH 1: 90 MHz”, “CH 2: 100 MHz”, or the like.

The operating unit 180 may receive the user input and transmit the user input to the control unit 190. The operating unit 180 may be configured as a button on the TV 100 or a remote controller. The user may input his intended command using the operating unit 180. For example, the user may select a desired transmission frequency using the operating unit 180.

The control unit 190 may determine a corresponding user command based on user input transmitted from the operating unit 180, and control the overall operations of the TV 100 according to the determined user command.

The control unit 190 may control the FM transmitting unit 160 so that the transmission frequency is selected from among the frequencies in the FM frequency band but not from the frequency in use. Specifically, the control unit 190 may determine which frequency is currently used for the transmission of TV broadcast, using the broadcast frequency information stored in the storage unit 170.

Specifically, the control unit 190 may carry out channel search, scan or the like to search for broadcast channels through which broadcast signals are currently received, extract the searched for channels and the corresponding frequencies, i.e., the frequencies in use, and store the extracted information in the storage unit 170 as the broadcast frequency information. In an exemplary embodiment, the scanning to search for the broadcast channels through which broadcast signals are received, may be performed by conventional methods. The control unit 190 may then set a transmittable frequency range based on a range that does not include the frequency included in the broadcast frequency information, and select the transmission frequency from within the transmittable frequency range. Herein, the ‘transmittable frequency range’ refers to a range of selectable transmission frequencies where there would be no signal confusion or interference, and this may include any frequency range that does not include the frequency used for TV broadcast.

The control unit 190 may apply various methods or algorithms to set the transmittable frequency range so that the transmittable frequency range does not include the frequency used for TV broadcast. For example, if the frequency for TV broadcast+6 MHz does not exceed 97.9 MHz, the control unit 190 may set a high frequency range (e.g., (the frequency for TV broadcast+6 MHz) to 107.9 MHz) to be the transmittable frequency range, while if the frequency for TV broadcast+6 MHz exceeds 97.9 MHz, the control unit 190 may set a low frequency range (e.g., 88.0 Mhz to (the frequency for TV broadcast−0.1 MHz)) to be the transmittable frequency range.

Additionally, if two frequencies (F1, F2) are used for TV broadcast, provided that F1<F2, the transmittable frequency range may be set as explained below.

If (F2−F1) is 8 MHz or greater, the control unit 190 may set the transmittable frequency range to be (F1+6 MHz) to (F2−0.1 MHz). If (F2−F1) is lower than 8 Mhz, the control unit 190 may set the transmittable frequency range in the high frequency range (i.e., (F2+6 MHz) to 107.9 MHz) if F2 is 97.9 Mhz or below, or in the low frequency range (i.e., 88.0 MHz to (F1−0.1 MHz)) if F2 exceeds 97.9 MHz.

Accordingly, the control unit 190 may set the transmittable frequency range in the manner explained above. However, the control unit 190 may apply various methods other than the ones explained above to set the transmittable frequency range, as long as the methods ensure that the frequency currently used for TV broadcast is not included in the transmittable frequency range.

Meanwhile, selecting the transmission frequency may be carried out automatically or manually. If selecting the transmission frequency is set to be automatic, the control unit 190 selects the transmission frequency automatically. In this case, the control unit 190 may automatically select a frequency from among the transmittable frequencies. The control unit 190 may then indicate or display the selected transmission frequency on the screen automatically so that the user can notice the transmission frequency.

If selecting the transmission frequency is set to be manual, the control unit 190 may select the transmission frequency according to the user input received through the operating unit 180. Accordingly, if the transmission frequency is selected manually, the control unit 190 may control so that a graphic user interface (GUI) for selecting transmission frequency appears on the screen. The control unit 190 may then select a frequency selected by the user through the GUI for selecting a transmission frequency as the transmission frequency.

The control unit 190 may control so that the frequency in use (i.e., frequency for TV broadcast) is not selected through the GUI for selecting a transmission frequency. For example, the control unit 190 may control so that only the frequencies in the transmittable frequency range appear on the GUI for selecting a transmission frequency. For example, if the transmittable frequency range is 99 MHz to 105 MHz, the control unit 190 may control so that the frequencies of 99 MHz to 105 MHz appear on the GUI for selecting a transmission frequency in units of 1MHz for selection by the user.

Additionally, the control unit 190 may control so that the frequencies in the transmittable frequency range are indicated or displayed as selectable in the GUI for selecting a transmission frequency, while the frequencies not included in the transmittable frequency range are indicated or displayed as non-selectable in the GUI for selecting a transmission frequency. For example, if the transmittable frequency range is 99 MHz to 105 MHz, the control unit 190 may determine the frequencies in the ranges of 88 MHz to 98 MHz and 106 MHz to 108 MHz to appear as non-selectable, while determining the frequencies 99 MHz to 105 MHz to appear in 1 MHz units as being selectable.

As explained above, since the control unit 190 determines the selected transmission frequency from the FM frequency band, while excluding the frequency used for TV broadcast, the FM transmitting unit 160 is able to transmit audio signals without having a signal confusion or interference with the TV broadcast signal.

As described above, the TV 100 having the built-in FM transmitter can transmit the audio signal in a FM frequency band. This will be explained with reference to FIG. 1B.

FIG. 1B illustrates an image system having a TV 100 including a built-in FM transmitter according to an exemplary embodiment. As shown in FIG. 1B, the TV 100 transmits audio signals to a home theater 10 using an FM frequency band. The home theater 10 includes an FM receiver to receive the audio signals over the FM frequency. The home theater 10 outputs the received audio signals through speakers of various channels. In an exemplary embodiment, a user would adjust the FM tuner in the home theater 10 to receive the particular FM frequency through which the audio signals are transmitted by the TV 100. In yet another exemplary embodiment, a user would adjust a setting in the home theater 10 so that the home theater 10 automatically tunes into the particular FM frequency through which the audio signals are transmitted by the TV 100, based on information received from the TV 100.

As described above, the TV 100 having the built-in FM transmitter transmits the audio signals to the home theater 10 wirelessly. Also, since the FM transmitter of the TV 100 selects a transmission frequency from the FM frequency band, while excluding the frequency used for TV broadcast, the TV 100 is able to transmit the audio signals without having a signal confusion or interference with a TV broadcast signal.

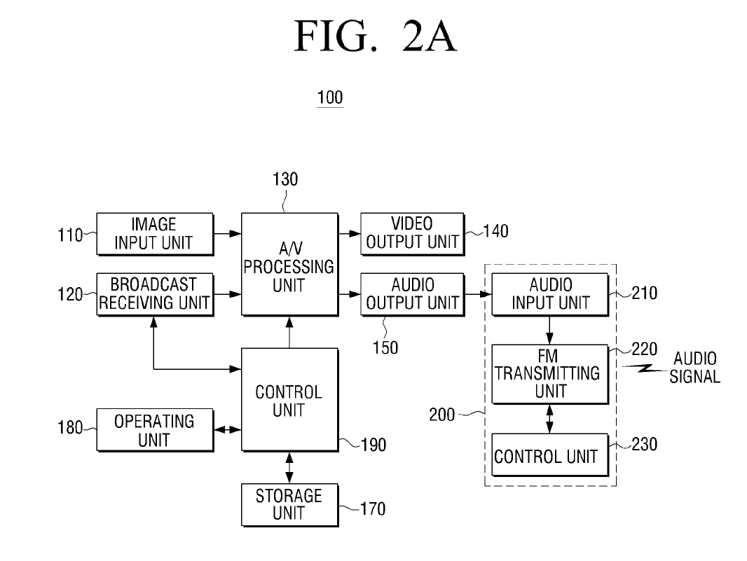

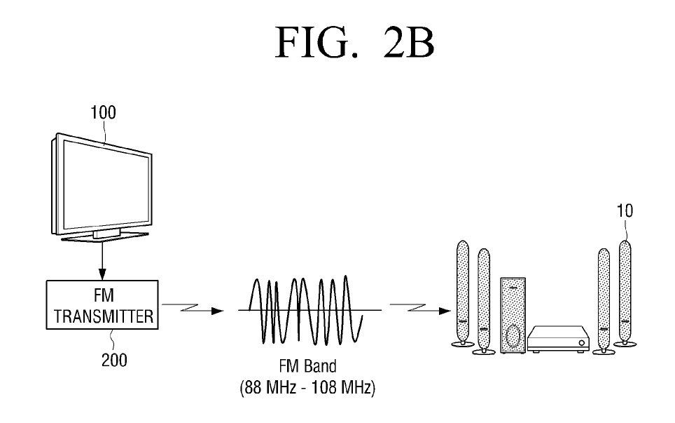

Although the FM transmitter in the exemplary embodiment explained above is included in the TV 100, this is written only for illustrative purpose. Therefore, other examples are applicable. For example, the FM transmitter may be externally connected to the TV 100. The example of employing the external FM transmitter will be explained below with reference to FIGS. 2A and 2B.

FIG. 2A illustrates the structure of the TV 100 to which the external FM transmitter 200 is connected. Since the TV 100 in FIG. 2A has almost the same structure as the TV 100 in FIG. 1A, only the differences will be explained below.

Referring to FIG. 2A, the external FM transmitter 200 may be connected to the audio output unit 150 by an audio cable to receive audio signal. The external FM transmitter 200 may include an audio input unit 210, a FM transmitting unit 220, and a control unit 230.

The audio input unit 210 may be connected to the audio output unit 150 of the TV 100 to receive an audio signal. Various forms of audio interfaces are applicable as the audio input unit 210.

The FM transmitting unit 220 may transmit the received audio signal through the transmission frequency in the FM frequency band.

The control unit 230 may control the FM transmitting unit 220 to select the transmission frequency from among the frequencies in the FM frequency band, but not the frequency in use. The control unit 230 may carry out similar functions as the control unit 190 explained above with reference to FIG. 1A, to prevent confusion of or interference with transmission frequency.

FIG. 2B illustrates an image system having a broadcast receiver to which the external FM transmitter 200 is connected.

Referring to FIG. 2B, the TV 100 may output an audio signal to the external FM transmitter 200. The external FM transmitter 200 may transmit the audio signal to the home theater 10 using the FM frequency band. The home theater 10 may include a FM receiver, and receive the audio signal through the FM frequency. Additionally, the home theater 10 may output the received audio signal through various channels of speakers.

As explained above, the external FM transmitter 200 may transmit the audio signal to the home theater 10 wirelessly. Furthermore, since the external FM transmitter 200 selects the transmission frequency from among the frequencies in the FM frequency band that exclude the frequency used for TV broadcast, the external FM transmitter 200 may transmit the audio signal without having confusion or signal interference with the TV broadcast signals.

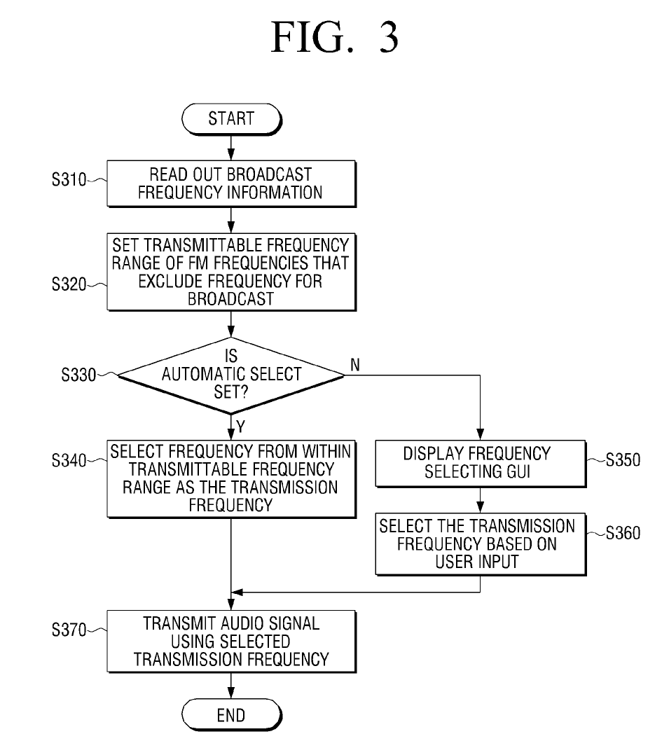

The method of transmitting an audio according to an exemplary embodiment will be explained below, with reference to FIG. 3. FIG. 3 is a flowchart provided to explain a method of transmitting an audio signal according to an exemplary embodiment. In the specific exemplary embodiment explained below, the TV 100 having a built-in FM transmitter is applied as one example. However, one will understand that the other examples, including an example of an external FM transmitter, are applicable according to exemplary embodiments.

At S310, the TV 100 may read out the broadcast frequency information stored in the storage unit 170. At S320, the TV 100 may set the transmittable frequency range so the range does not include the frequency for broadcast. Specifically, the TV 100 may determine which frequency is currently used to receive the TV broadcast, using the broadcast frequency information stored in the storage unit 170.

Specifically, the TV 100 may carry out channel search or the like to search the broadcast channels through which the broadcast signal is currently received, extract the searched channels and the corresponding frequencies, and store the extracted information in the storage unit 170 as the broadcast frequency information. The TV 100 may then set the transmittable frequency range so the range does not include the frequency included in the broadcast frequency information, and select the transmission frequency from within the transmittable frequency range. The TV 100 may apply various methods in setting the transmittable frequency range so that the transmittable frequency range does not include the frequency used for TV broadcast.

At S330, the TV 100 may determine if selecting the transmission frequency is set to be carried out automatically or not. At S330-Y, if selecting the transmission frequency is set to be carried out automatically, at S340, the TV 100 may select the transmission frequency from among the transmittable frequency range automatically. The TV 100 may then indicate or display the selected transmission frequency on the screen automatically, so that the user notices the transmission frequency.

At S330-N, if selecting the transmission frequency is set to be carried out manually, at S350, the TV 100 may display a GUI for selecting a transmission frequency on the screen. At S360, the TV 100 may determine the transmission frequency according to the user input received through the operating unit 180.

The TV 100 ensures that the frequency in current use (i.e., frequency for TV broadcast) is not selected on the GUI for selecting a transmission frequency. For example, the TV 100 may indicate or display only the frequencies within the transmittable frequency range on the transmittable frequency selecting GUI. Alternatively, the TV 100 may indicate or display the frequencies within the transmittable frequency range as selectable frequencies on the GUI, while indicating the frequencies not included in the transmittable frequency range as non-selectable frequencies.

At S370, the TV 100 may transmit the audio signal to the outside using the selected transmission frequency.

As explained above, since the TV 100 selects the transmission frequency of FM frequency band from among the frequencies other than the frequency used for TV broadcast, the TV 100 may transmit an audio signal without having confusion or interference with the TV broadcast signals.

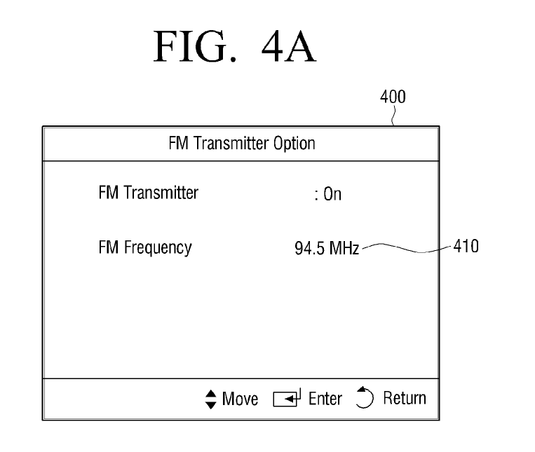

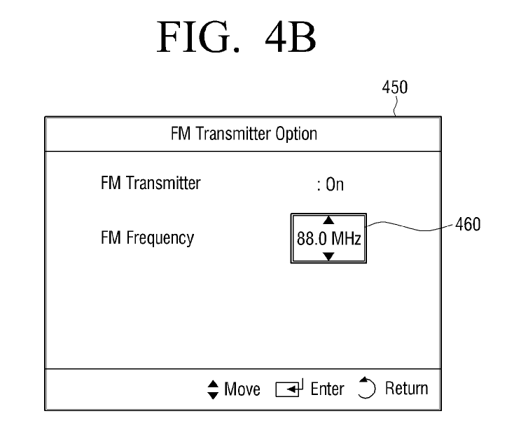

The GUI for selecting a transmission frequency will be explained in detail below, with reference to FIGS. 4A and 4B. FIG. 4A illustrates a frequency selecting GUI 400 in automatic select mode according to one exemplary embodiment, in which the transmission frequency is selected automatically.

Referring to FIG. 4A, the GUI for selecting a transmission frequency 400 in automatic select mode may indicate or display an automatically-set transmission frequency value 410. In FIG. 4A, the transmission frequency value 410 is set to be 94.5 HMz.

FIG. 4B illustrates a frequency selecting GUI 450 in manual select mode according to another exemplary embodiment, in which the transmission frequency is selected manually by the user. Referring to FIG. 4B, the GUI for selecting a transmission frequency 450 in manual select mode may display a frequency select box 460.

If a user input is in an upward direction, the frequency indicated or displayed in the frequency select box 460 increases by 1 MHz. If the user input is in a downward direction, the frequency in the frequency select box 460 decreases by 1 MHz. the frequency select box 460 may indicate or display only the frequencies within the transmittable frequency range. Accordingly, it is ensured that the user sets the transmission frequency within the transmittable frequency range.

As explained above, the user can select the frequency and confirm his selection using the frequency selecting GUI.

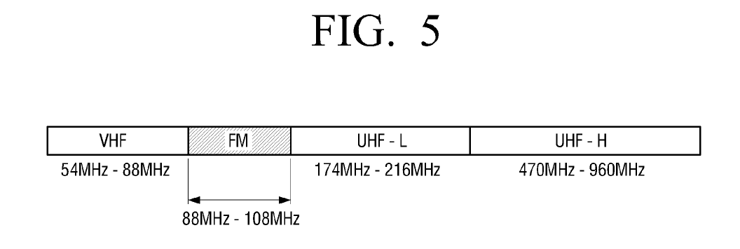

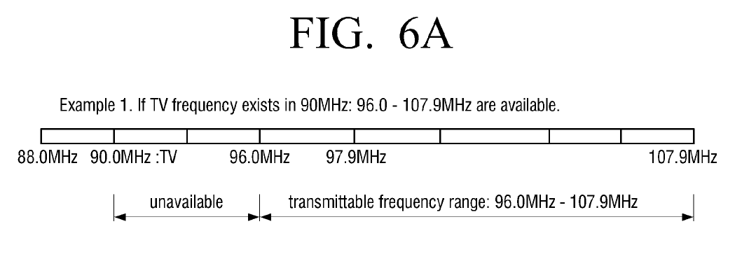

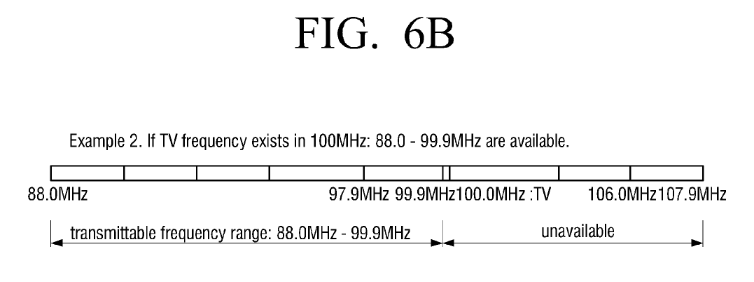

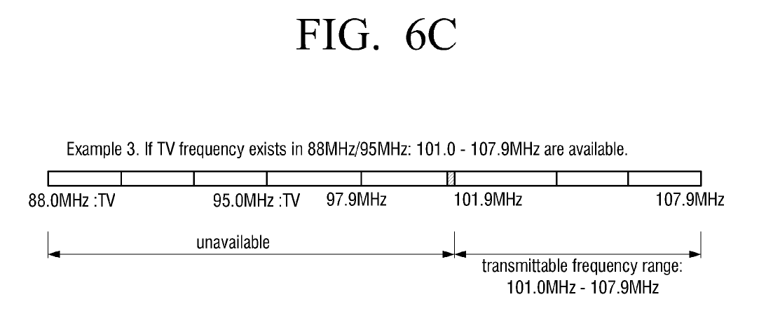

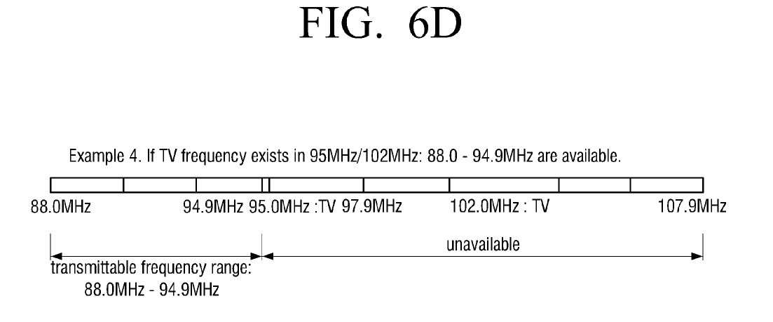

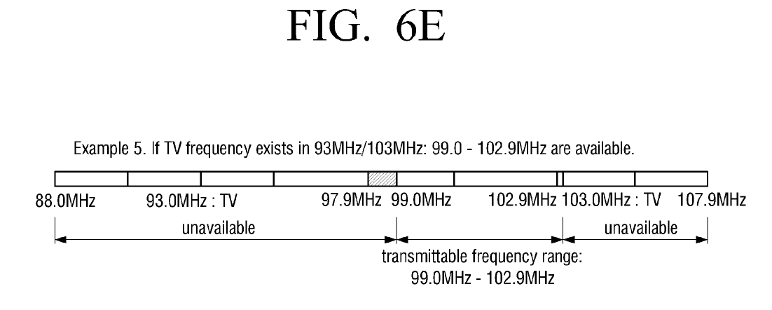

Selecting a transmittable frequency range according to one exemplary embodiment will be explained below, with reference to FIGS. 5 to 6E.

FIG. 5 illustrates the FM frequency band according to one exemplary embodiment. Referring to FIG. 5, the FM frequency band is 88 MHz to 108 MHz.

FIGS. 6A to 6E illustrate the examples of setting the transmittable frequency range according to one exemplary embodiment.

FIG. 6A illustrates an example of setting the transmittable frequency range when 90 MHz is used as the frequency for TV broadcast. If there is one frequency used for TV broadcast, the FM transmitter may set the high frequency range (i.e., (the frequency for TV broadcast+6 MHz) to 107.9 MHz) as the transmittable frequency range, if frequency for TV broadcast+6 MHz is lower than 97.9 MHz. Accordingly, as illustrated in FIG. 6A, if 90 MHz is used as the frequency for TV broadcast, the FM transmitter sets 96.0 MHz to 107.9 MHz as the transmittable frequency range.

FIG. 6B illustrates an example of setting the transmittable frequency range when 100 MHz is used as the frequency for TV broadcast.

If there is one frequency used for TV broadcast, the FM transmitter may set the low frequency range (i.e., 88.0 MHz to (the frequency for TV broadcast−0.1 MHz)) as the transmittable frequency range, if frequency for TV broadcast+6 MHz exceeds 97.9 MHz. Accordingly, as illustrated in FIG. 6B, if 100 MHz is used as the frequency for TV broadcast, the FM transmitter sets 88.0 MHz to 99.9 MHz as the transmittable frequency range.

FIG. 6C illustrates an example of setting the transmittable frequency range when 88 MHz and 95 MHz are used as the frequency for TV broadcast.

If there are two frequencies (F1, F2) used for TV broadcast, provided that F1<F2, the FM transmitter may set the high frequency range (i.e., (F2+6 MHz) to 107.9 MHz) as the transmittable frequency range, if (F2−F1) is lower than 8 MHz and F2 is 97.9 MHz or below. Accordingly, as illustrated in FIG. 6C, if 88 MHz and 95 MHz are used as the frequencies for TV broadcast, the FM transmitter sets 101.0 MHz to 107.9 MHz as the transmittable frequency range.

FIG. 6D illustrates an example of setting the transmittable frequency range when 95 MHz and 102 MHz are used as the frequency for TV broadcast.

If there are two frequencies (F1, F2) used for TV broadcast, provided that F1<F2, the FM transmitter may set the low frequency range (i.e., 88.0 MHz to (F1−0.1 MHz)) as the transmittable frequency range, if (F2−F1) is lower than 8 MHz and F2 exceeds 97.9 MHz. Accordingly, as illustrated in FIG. 6D, if 95 MHz and 102 MHz are used as the frequencies for TV broadcast, the FM transmitter sets 88.0 MHz to 94.9 MHz as the transmittable frequency range.

FIG. 6E illustrates an example of setting the transmittable frequency range when 93 MHz and 103 MHz are used as the frequency for TV broadcast.

If there are two frequencies (F1, F2) used for TV broadcast, provided that F1<F2, the FM transmitter may set F1+6 MHz to (F2−0.1 MHz) as the transmittable frequency range, if (F2−F1) is 8 MHz or above. Accordingly, as illustrated in FIG. 6E, if 93 MHz and 103 MHz are used as the frequencies for TV broadcast, the FM transmitter sets 99.0 MHz to 102.9 MHz as the transmittable frequency range.

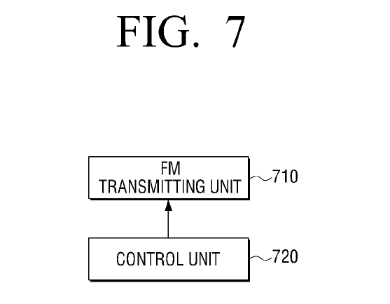

FIG. 7 illustrates a FM transmitter according to one exemplary embodiment.

Referring to FIG. 7, the FM transmitter in one exemplary embodiment may include a FM transmitting unit 710 and a control unit 720.

The FM transmitting unit 710 may transmit an audio signal using a frequency in the FM frequency band. The control unit 720 controls the FM transmitting unit 710 to select the frequency in the FM frequency band from among the frequencies other than the frequency in use.

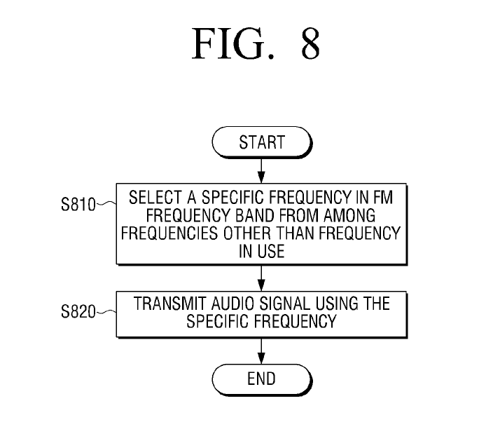

FIG. 8 is a flowchart provided to explain a method of transmitting an audio according to one exemplary embodiment.

At S810, the FM transmitter may select a frequency in the FM frequency band, from among the frequencies that exclude the frequency in use. At S820, the FM transmitter transmits an audio signal using the selected frequency in the FM frequency band.

Although the TV is explained above as an example of a broadcast receiver according to one exemplary embodiment, any other devices that can receive a broadcast and transmit the audio signal over the FM frequency band, are equally applicable. For example, the broadcast receiver may be configured as a settop box, a DMB receiver, or the like.

The foregoing exemplary embodiments and advantages are merely exemplary and are not to be construed as limiting the present inventive concept. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A frequency modulation (FM) transmitter comprising:
an FM transmitting unit; and
a control unit which controls the FM transmitting unit so that a frequency in an FM frequency band is selected from among frequencies that are not in use,
wherein the FM transmitting unit transmits an audio signal through the selected frequency in the FM frequency band.

2. The FM transmitter of claim 1, further comprising a storage unit which stores broadcast frequency information used for a television (TV) broadcast,
wherein the control unit controls so that the selected frequency is selected using the broadcast frequency information.

3. The FM transmitter of claim 2, wherein the control unit controls so that the selected frequency is selected from within a range that does not include a frequency in the broadcast frequency information.

4. The FM transmitter of claim 1, wherein the control unit automatically selects the selected frequency in the FM frequency band from among the frequencies that are not in use.

5. The FM transmitter of claim 1, wherein the control unit selects the frequency according to a user input.

6. The FM transmitter of claim 5, wherein the control unit controls a display unit to display a graphic user interface (GUI) for selecting the frequency and selects the frequency according to the user input received through the GUI.

7. The FM transmitter of claim 6, wherein the control unit controls the GUI so that a frequency in use in the FM frequency band is not selectable.

8. The FM transmitter of claim 1, further comprising an audio input unit which receives an audio signal from an external device,
wherein the FM transmitting unit transmits the received audio signal using the selected frequency.

9. A broadcast receiver comprising the FM transmitter of claim 1.

10. A method of transmitting an audio, the method comprising:
selecting a frequency in a frequency modulation (FM) band from among frequencies that are not in use; and
transmitting an audio signal using the selected frequency.

11. The method of claim 10, further comprising reading out broadcast frequency information used for television (TV) broadcast,
wherein the selecting comprises selecting the frequency using the broadcast frequency information.

12. The method of claim 11, wherein the selecting further comprises selecting the frequency from within a range that does not include a frequency in the broadcast frequency information.

13. The method of claim 10, wherein the selecting comprises automatically selecting the frequency from among the frequencies in the FM frequency band not including the frequency in use.

14. The method of claim 10, wherein the selecting comprises selecting the frequency selected by a user input.

15. The method of claim 14, further comprising displaying a graphic user interface (GUI) for selecting the frequency,
wherein the selecting selects the frequency according to the user input received through the GUI.

16. The method of claim 15, wherein the GUI is configured so that a frequency in the FM frequency band is not selected as the selected frequency if the frequency in the FM frequency band is in use.

17. The method of claim 10, further comprising receiving an audio signal from an external device,
wherein the transmitting comprises transmitting the received audio signal using the selected frequency.

18. The method of claim 10, wherein the FM frequency band comprises a used frequency through which a television broadcast signal is transmitted, and the method further comprises setting a usable range of frequencies of the FM frequency band that does not include the used frequency, as the frequencies that are not in use.

19. The method of claim 18, wherein if the used frequency is above a predetermined frequency, the usable range of frequencies is below the predetermined frequency and if the used frequency is below the predetermined frequency, the usable range of frequencies is above the predetermined frequency.

20. The method of claim 18, wherein the used frequency comprises two used frequencies, and if a difference between the two used frequencies are greater than a threshold level, the usable range of frequencies is set to be between the two used frequencies and if the difference is less than the threshold level, then one of a high range of frequencies above the two used frequencies or a low range of frequencies below the two used frequencies is set as the usable range of frequencies.

21. A display device comprising:
a display unit;
a frequency modulation (FM) transmitting unit; and
a controller which controls the FM transmitting unit so that a frequency in an FM frequency band is selected from among frequencies that are not in use,
wherein the FM transmitting unit transmits an audio signal through the selected frequency in the FM frequency band.

22. The display device of claim 21, wherein the controller controls the display unit to display a graphic user interface (GUI) which indicates at least one of frequencies that is not in use and that is manually selectable by a user to transmit the audio signal.

23. The display device of claim 21, wherein the controller controls the display unit to display a graphic user interface (GUI) which indicates one of frequencies that is not in use and that is automatically selected by the controller to transmit the audio signal.
